(19) United States
(12) Patent Application Publication
(10) Pub. No.: US 2017/0017316 A1
(43) Pub. Date: Jan. 19, 2017

(54) Tactile Input System

(71) Applicant: Larry Skitton, Shirley, NY (US)

(72) Inventor: Larry Skitton, Shirley, NY (US)

(21) Appl. No.: 14/802,198

(22) Filed: Jul. 17, 2015

(51) Int. Cl. G06F 3/041

(52) U.S. Cl. CPC G06F 3/041

(57) ABSTRACT

A tactile input system includes an electronic device that has a touchpad. The electronic may be manipulated thereby facilitating the electronic device to be controlled. A sheet is removably coupled to the touchpad such that the sheet protects the touchpad from becoming scratched or damaged. The sheet is comprised of a bendable material and the sheet is comprised of a scratch resistant material.

### BACKGROUND OF THE DISCLOSURE

Field of the Disclosure

The disclosure relates to input devices and more particularly pertains to a new input device for protecting a touchpad on an electronic device.

### SUMMARY OF THE DISCLOSURE

An embodiment of the disclosure meets the needs presented above by generally comprising an electronic device that has a touchpad. The electronic may be manipulated thereby facilitating the electronic device to be controlled. A sheet is removably coupled to the touchpad such that the sheet protects the touchpad from becoming scratched or damaged. The sheet is comprised of a bendable material and the sheet is comprised of a scratch resistant material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a tactile input system according to an embodiment of the disclosure.

FIG. 2 is a bottom perspective view of an embodiment of the disclosure.

FIG. 3 is a cross sectional view taken along line 3-3 of FIG. 1 of an embodiment of the disclosure.

FIG. 4 is a top view of an embodiment of the disclosure.

FIG. 5 is a perspective in-use view of an embodiment of the disclosure.

### DESCRIPTION OF THE PREFERRED EMBODIMENT

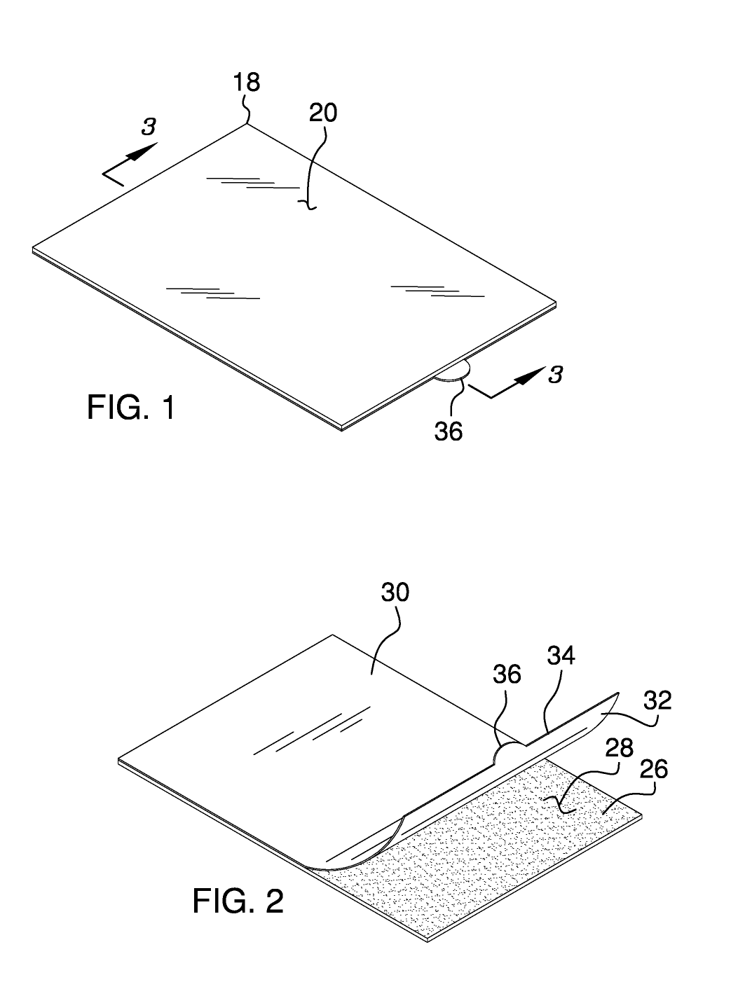

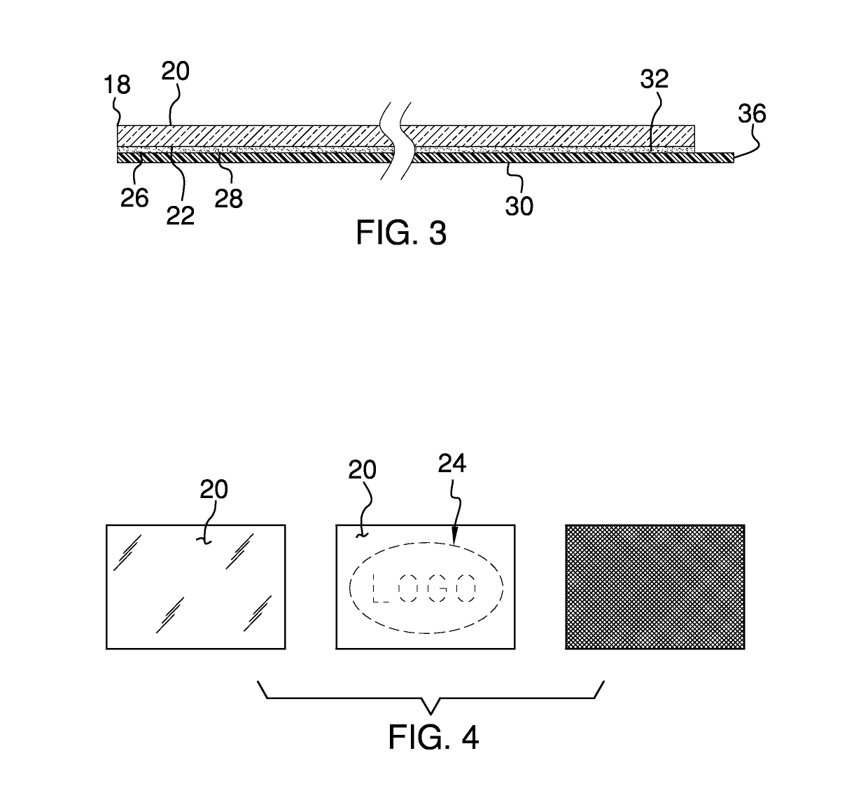

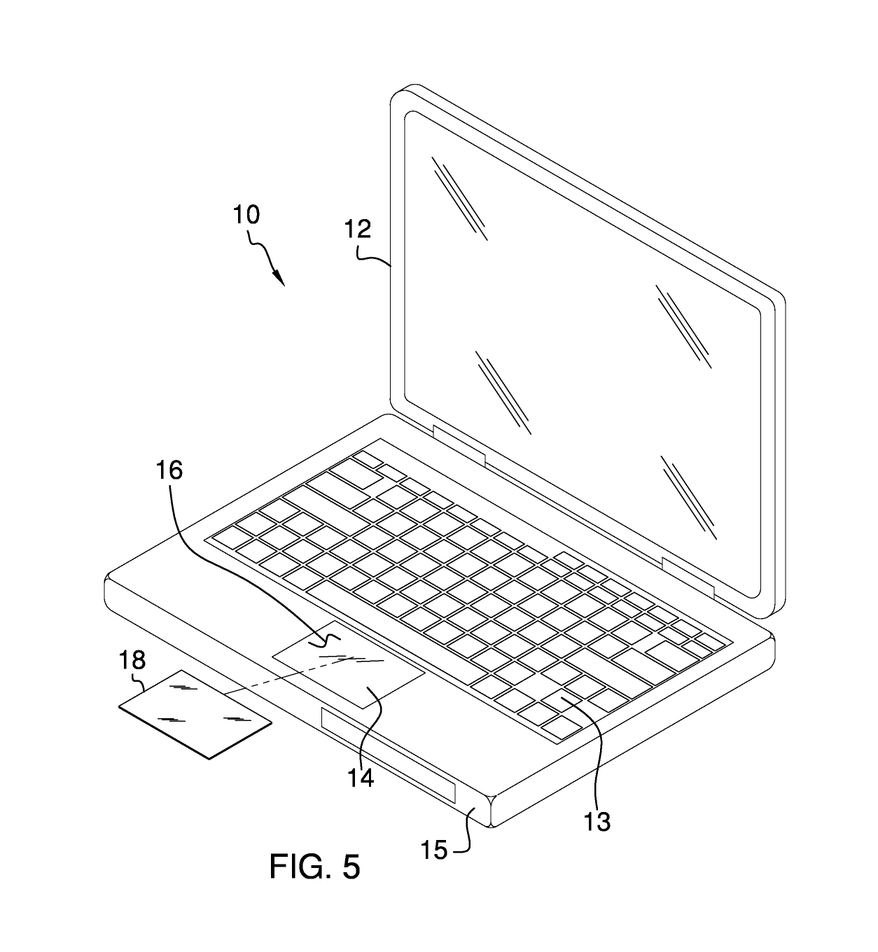

With reference now to the drawings, and in particular to FIGS. 1 through 5 thereof, a new input device embodying the principles and concepts of an embodiment of the disclosure and generally designated by the reference numeral 10 will be described.

As best illustrated in FIGS. 1 through 5, the tactile input system 10 generally comprises an electronic device 12 that has a touchpad 14 and the touchpad 14 has an exposed surface 16. The electronic device 12 may have a keyboard 13 and a front edge 15. The touchpad 14 may be positioned between the keyboard 13 and the front edge 15. The exposed surface 16 may be manipulated thereby facilitating the electronic device 12 to be controlled. The electronic device 12 may comprise a laptop computer or the like and the touchpad 14 may comprise a touch sensitive mouse pad or the like.

A sheet 18 is removably coupled to the touchpad 14 such that the sheet 18 protects the touchpad 14 from becoming scratched or damaged. The sheet 18 has a top surface 20 and a bottom surface 22. The sheet 18 is comprised of a bendable and scratch resistant material. The sheet 18 may be translucent or the sheet 18 may have a solid color. The top surface 20 may have indicia 24 printed thereon and the indicia 24 may comprise an image or a logo.

Alternatively, the sheet 18 may be comprised of a rigid and shatter resistant material. The rigid and shatter resistant material may comprise tempered glass or the like. The sheet 18 comprised of the rigid and shatter resistant material may be installed by the manufacturer of the electronic device 12.

An adhesive layer 26 is coupled to the sheet 18 and the adhesive layer 26 completely covers the bottom surface 22. The adhesive layer 26 has an adhering surface 28. The adhering surface 28 adhesively engages the exposed surface 16 such that the sheet 18 is removably retained on the touchpad 14. The adhesive layer 26 may comprise a non residual adhesive or the like.

A backing 30 is provided and the backing 30 has a first side 32 and a first edge 34. The first side 32 is removably adhered to the adhering surface 28 such that the backing 30 completely covers the adhering surface 28. Thus, the backing 30 protects the adhesive layer 26 from becoming contaminated. The first edge 34 has a tab 36 extending away from the backing 30. The tab 36 extends beyond the adhesive layer 26. Thus, the tab 36 be gripped thereby facilitating the backing 30 to be removed from the adhesive layer 26.

In use, the tab 36 is gripped and the backing 30 is removed from the adhesive layer 26. The sheet 18 is manipulated to facilitate the adhering surface 28 to adhere to the exposed surface 16 of the touch pad 14. Additionally, the sheet 18 is positioned to completely cover the touch pad 14. The sheet 18 is removed and replaced when the sheet 18 becomes tarnished or blemished.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tactile input system comprising:
an electronic device having a touchpad, said electronic being configured to be manipulated thereby facilitating said electronic device to be controlled; and
a sheet being removably coupled to said touchpad such that said sheet protects said touchpad from becoming scratched or damaged, said sheet being comprised of a bendable material said sheet being comprised of a scratch resistant material.

2. The system according to claim 1, further comprising:
said sheet having a top surface and a bottom surface; and
an adhesive layer being coupled to said sheet, said adhesive layer completely covering said bottom surface, said adhesive layer having an adhering surface, said adhering surface adhesively engaging said exposed surface such that said sheet is removably retained on said touchpad.

3. The system according to claim 1, further comprising:
an adhesive layer having an adhering surface; and
a backing having a first side and a first edge, said first side being removably adhered to said adhering surface such that said backing completely covers said adhering surface.

4. The system according to claim 3, wherein said first edge has a tab extending away from said backing, said tab extending beyond said adhesive layer wherein said tab is configured to be gripped thereby facilitating said backing to be removed from said adhesive layer.

5. A tactile input system comprising:
an electronic device having a touchpad, said touchpad having an exposed surface, said exposed surface being configured to be manipulated thereby facilitating said electronic device to be controlled;
a sheet being removably coupled to said touchpad such that said sheet protects said touchpad from becoming scratched or damaged, said sheet having a top surface and a bottom surface, said sheet being comprised of a bendable material, said sheet being comprised of a scratch resistant material;
an adhesive layer being coupled to said sheet, said adhesive layer completely covering said bottom surface, said adhesive layer having an adhering surface, said adhering surface adhesively engaging said exposed surface such that said sheet is removably retained on said touchpad; and
a backing having a first side and a first edge, said first side being removably adhered to said adhering surface such that said backing completely covers said adhering surface, said first edge having a tab extending away from said backing, said tab extending beyond said adhesive layer wherein said tab is configured to be gripped thereby facilitating said backing to be removed from said adhesive layer.
